(19) United States
(12) Patent Application Publication
(10) Pub. No.: US 2025/0285335 A1
(43) Pub. Date: Sep. 11, 2025

(54) COMPRESSION AND DECOMPRESSION OF A THREE-DIMENSIONAL SCENE REPRESENTATION

(71) Applicant: Disguise Technologies Limited, London (GB)

(72) Inventor: Dominic Brown, London (GB)

(73) Assignee: Disguise Technologies Limited, London (GB)

(21) Appl. No.: 18/862,518

(22) PCT Filed: Apr. 28, 2023
(86) PCT No.: PCT/GB2023/051143

§ 371 Date: Nov. 1, 2024

(30) Foreign Application Priority Data
May 2, 2022 (GB) 2206377.0

(51) Int. Cl. G06T 9/00; G06T 7/00; G06T 15/20

(52) U.S. Cl. CPC G06T 9/00; G06T 7/0002; G06T 15/20; G06T 2207/20021

(57) ABSTRACT

CLEAN COPY OF THE ABSTRACT AS AMENDED

Disclosed are methods and systems for compressing a representation of a three-dimensional scene and decompressing a compressed representation of the scene. Compressing a representation of the scene may comprise detecting a subset of position parameters included in the scene, which are indicative of positions of discontinuities in measures of a property of the scene; and storing the subset of the plurality of position parameters and the measures of the property of the scene corresponding to the subset of the plurality of position parameters as a compressed representation of the scene. A compressed representation of a three-dimensional scene may comprise first measures of a property of the scene corresponding to a plurality of first position parameters indicative of first positions in the scene. Decompressing the compressed representation of the scene may comprise determining second measures of the property of the scene.

### FIELD OF THE INVENTION

The present disclosure relates to computing apparatus and methods for compressing and decompressing representations of three-dimensional scenes. The computing apparatus and methods may find particular application in rendering of three-dimensional scenes to generate images for display.

### BACKGROUND

Rendering a scene to generate images for display may find a variety of different applications in fields such as the creation of visual effects for display at live-audience events or for inclusion in recorded media such as television programmes and/or films. Additionally or alternatively, rendering of three-dimensional scenes may find application in generating graphics for video games and/or simulators. A three-dimensional scene to be rendered may for example, comprise a virtual scene which has been computer generated. Additionally, or alternatively, the scene to be rendered may include at least some components of a real-world scene which have been captured and/or measured. In at least some applications, rendering may facilitate the creation of extended reality (XR) experiences which may include augmented reality (AR), mixed reality (MR) and virtual reality (VR).

Rendering of a three-dimensional scene to generate images for display, typically requires a representation of one or more properties of the three-dimensional scene expressed for a plurality of different positions in the scene. For example, representations may be provided of properties related to the geometry of objects in the scene, such as the location, shape and/or orientation of surfaces in the scene. Such representations may be used to determine the appearance of objects in the scene when viewed from particular viewing positions so as to render an image of a scene as viewed from a given viewing position.

In at least some rendering applications it may be desirable to compress a representation of a three-dimensional scene so as to produce a compressed representation occupying less memory than the full uncompressed representation. It may be further desirable to decompress the compressed representation so as to reconstruct an approximation of the original representation of the scene.

It is in this context that the subject matter contained in the present application has been devised.

### SUMMARY OF THE INVENTION

It has been realised that representations of a three-dimensional scene often include relatively low frequency information and any high frequency features may be discarded without a significant loss of information. For example, properties of a three-dimensional scenes often undergo sharp transitions at the edge of different objects in the scene and may, for example, be relatively uniform and/or vary relatively uniformly as a function of position in regions between such sharp transitions. It has been further realised that a representation of a three-dimensional scene may be efficiently compressed by identifying discontinuities in measures of a property of the scene and storing the position of the discontinuities along with the measures of the property at the discontinuity positions as a compressed representation of the scene. Such a compression may achieve relatively high compression ratios whilst retaining much of the important information in the scene representation. For example, retaining lower frequency information related to discontinuities in the scene property and discarding higher frequency information when compressing a representation of the scene may retain sufficient information such that the compressed representation may be decompressed and used to render an image of the scene without significant loss of quality.

It has also been found that the compression and decompression methods disclosed herein may be particularly suitable for implementation on graphics processing units (GPUs). In particular, the methods disclosed herein are particularly suitable for parallelisation such that multiple processing cores and/or multiple processing units can perform aspects of the method steps disclosed herein in parallel with each other. This may significantly improve the speed at which the compression and decompression may be performed according to the methods disclosed herein. This may be particularly advantageous for real-time rendering applications.

According to a first aspect of the present disclosure there is provided a computer implemented method of compressing a representation of a three-dimensional scene, wherein the representation comprises measures of a property of the scene corresponding to a plurality of different position parameters indicative of positions in the scene, the method comprising: detecting a first subset of the plurality of position parameters, which are indicative of positions of discontinuities in the measures of the property of the scene; and storing the first subset of the plurality of position parameters and the measures of the property of the scene corresponding to the first subset of the plurality of position parameters as a compressed representation of the scene.

In some examples, the plurality of different position parameters may each fully define a three-dimensional position in the scene. In at least some examples, the plurality of different position parameters may each define a position in the scene in one or two dimensions.

The position parameters may be indicative of a position in two dimensions. For example, the measures of a property of the scene may correspond with a plurality of different two-dimensional positions in the scene. Each position parameter may comprise a set of two co-ordinates. The two co-ordinates in each set of two co-ordinates may relate to two different dimensions. That is, each position parameter may be expressed as a set of two-dimensional co-ordinates. For example, each measure of the property of the scene may be associated with a different set of two-dimensional co-ordinates. A set of two-dimensional co-ordinates may, for example, include a position on an x-axis and a position on a y-axis (or equivalently a position on a u-axis and a position on a v-axis). The position on the x-axis and the position on the y-axis may correspond to positions of pixels in an image to be rendered based on the representation of the three-dimensional scene. Equivalently, the position on the x-axis and the position on the y-axis may correspond respectively to viewing angles or directions in two-dimensions from a viewing position. The viewing position may represent a viewing position relative to which an image is to be rendered based on the representation of the three-dimensional scene.

In at least some examples, the property of the scene may comprise a position in a third dimension and the measures of the property of the scene may comprise a position of a feature (such as a surface) in the scene in the third dimension. In at least some examples, the position in a third dimension may be expressed as a distance from a viewing position.

The property of the scene may be a property of surfaces in the scene. For example, the property of the scene may relate to geometry, material properties and/or optical properties of surfaces in the scene. The property of the scene may additionally or alternatively relate to lighting, illumination and/or shadowing properties of a scene expressed as a function of the position parameters.

In at least some examples, the measures of a property of the scene corresponding to a plurality of different position parameters indicative of positions in the scene may be expressed as an image. For example, each measure of the property of the scene may be expressed as a pixel brightness and the position parameter to which the measure corresponds may determine the position in the image at which the measure is expressed as a pixel brightness.

Detecting a first subset of the plurality of position parameters, which are indicative of positions of discontinuities in the measures of the property of the scene may comprise performing one or more edge detection process to detect the discontinuities. For example, when the measures are expressed as an image, any suitable edge detection process may be performed on the image to identify positions of discontinuities in the measures.

The compressed representation of the scene may be fully expressed as a subset of the plurality of different position parameters included in the uncompressed representation and the measures of the property of the scene corresponding to the subset of the plurality of different position parameters. The subset of the plurality of different position parameters includes at least the detected first subset. In at least some examples, the subset of the plurality of different position parameters which express the compressed representation may include one or more additional subsets (in addition to the detected first subset) of position parameters and the measures of the property of the scene corresponding to the one or more additional subsets.

The compressed representation of the scene may not include any additional information defining how the measures of the property of the scene vary in between the positions indicated by the subset of position parameters included in the compressed representation. For example, the method of compressing the representation may not include fitting any functions to the measures of the property of the scene. The compressed representation may not include any function parameters defining functions which express variations of the measures of the property of the scene.

Fully expressing a compressed representation of the scene as a subset of the plurality of different position parameters included in the uncompressed representation and the measures of the property of the scene corresponding to the subset of the plurality of different position parameters, may allow high levels of compression ratios to be achieved. Furthermore, such compression methods may allow the compressed representation to be uncompressed to reproduce the original representation with a high degree of accuracy.

The representation of the three-dimensional scene may be suitable for use in rendering an image of the scene. That is, the property of the scene may be a property which is used to render an image of the three-dimensional scene. The plurality of different position parameters in the scene may correspond with different pixels in an image rendered based on the representation of the scene. For example, there may be a one-to-one mapping between the plurality of position parameters and pixels in an image to be rendered using the representation of the scene.

The measures of a property of the scene may comprise measures of a property of surfaces in the scene corresponding to the plurality of different position parameters.

The property may, for example, relate to material and/or optical properties of surfaces in the scene expressed at the plurality of different position parameters. For example, the measures of the property of the scene may be indicative of a reflectivity of surfaces in the scene and may, for example, be expressed as an albedo. A measure of reflectively and/or albedo may, for example, be expressed for a plurality of different colours (e.g. red, green and blue). In at least some examples, the measures of the property of the scene may comprise at least one of a red albedo, a blue albedo and a green albedo.

In a least some examples, the measures of the property of the scene may be indicative of optical distortion caused by surfaces in the scene. In at least some examples, the measures of the property of the scene may be indicative of a colour of surfaces in the scene.

The measures of a property of surfaces in the scene may comprise measures indicative of geometry of surfaces in the scene corresponding to the plurality of different position parameters.

For example, the property may relate to the position, shape and/or orientation of surfaces in the scene. In at least some examples, the property may relate to a distance of surfaces from a reference position or plane (e.g. a viewing position). In at least some examples, the property may relate to an orientation of surfaces in the scene. The orientation of surfaces may, for example, be expressed as a direction of a surface normal. The measures of a property of the scene may, for example, comprise measures of surface normal directions corresponding to a plurality of different position parameters (which may for example, relate to different pixels in an image to be rendered or equivalently different viewing directions from a viewing position).

The plurality of different position parameters may correspond with a plurality of different viewing directions originating at a viewing position. Each of the measures of a property of the scene may correspond with a viewing direction of the plurality of viewing directions.

The plurality of different viewing directions may equivalently be thought of as a plurality of different rays, each passing through the viewing position. The plurality of different rays may, for example, correspond with rays used in rendering techniques such as ray casting.

The plurality of different viewing directions may be characterised in two dimensions. For example, the plurality of different viewing directions may relate to different positions on an x and y-axis (or equivalent u and v axes). The x and y-axis may directly relate to positions of pixels in an image to be rendered based on the representation of the scene. Additionally or alternatively, the plurality of different viewing directions may be expressed as different angles of the viewing directions originating from the viewing position. Each viewing direction may be expressed as angles in two-dimensions relative to some reference direction. For example, each viewing direction may be expressed as a polar angle and an azimuthal angle.

The representation of the three-dimensional scene may comprise a depth map. The measures of a property of the scene may comprise distances to a surface in the three-dimensional scene along the plurality of different viewing directions from the viewing position.

The distances may comprise a distance to a closest surface in the scene from the viewing position and along the respective viewing direction. For example, the distances may be thought of as a distance along a ray originating at the viewing position and extending in the respective viewing direction, the distance being the distance along the ray until the ray first intercepts a surface in the scene.

In at least some examples, the distances may additionally or alternatively comprise at least some distances to an occluded surface in the scene, when viewed from the viewing position. For example, at least some distances may comprise a distance to a second, third or subsequent surface which is intercepted by a ray originating from the viewing position and extending in the respective viewing direction.

Detecting the first subset of the plurality of position parameters which are indicative of positions of discontinuities in the measures of the property of the scene may comprises determining derivatives of the measures of the property of the scene with respect to changes in the position parameter; determining the first subset of the plurality of position parameters as position parameters at which a magnitude of the determined derivatives is greater than a derivate threshold.

The derivates of the measures of the property of the scene may comprise a combination of a derivate of the measures determined with respect to changes in position in a first dimension (e.g. an x-direction) and a derivate of the measures determined with respect to changes in position in a second dimension (e.g. a y-direction). The derivatives may be expressed as absolute derivatives or equivalently as magnitudes of determined derivatives.

The derivatives may be determined by performing an operation on the measures of the property of the scene corresponding to the plurality of different position parameters property expressed as an image. For example determining the derivatives may comprise performing a convolution of the measures expressed as an image and a kernel.

The derivates of the measures of the property of the scene with respect to changes in the position parameter may comprise first derivatives with respect to changes in the position parameter. Determining the derivatives may comprise performing a convolution of the measures of the property of the scene expressed as an image and a kernel such as a Sobel operator, a Scharr operator and/or a Prewitt operator.

The derivative threshold may be a pre-determined threshold. Additionally or alternatively, the derivative threshold may be determined in dependence on one or more properties of the representation of the scene. For example, the derivative threshold may be determined for each scene representation and may be set in order to achieve a desired compression ratio.

Determining derivatives of the measures of the property of the scene may comprise determining second derivatives of the measures of the property of the scene with respect to changes in the position parameter.

Determining the derivatives may comprise determining first derivates of the measures of the property of the scene with respect to changes in the position parameter and further determining first derivates of the determined first derivates of the measures of the property of the scene, so as to compute second derivatives of the measures of the property of the scene with respect to changes in the position parameter. For example, a kernel such as a Sobel operator, a Scharr operator and/or a Prewitt operator may be applied twice to compute the second derivatives.

Determining the derivatives may comprise performing a convolution of the measures of the property of the scene expressed as an image and a kernel configured to compute a second derivative. The kernel may, for example, comprise a Laplacian kernel.

The computer implemented method may further comprise: determining the derivative threshold in dependence on the number of position parameters at which the magnitude of the determined derivatives is greater than the derivative threshold.

The derivative threshold may be determined so as to achieve a desired compression ratio. For example, it may be desirable for the compressed representation of the scene to include a target percentage or less of the data points in the original uncompressed representation of the scene. A derivative threshold may be determined which results in the number of position parameters at which the magnitude of the determined derivatives is greater than the derivative threshold is a target percentage or less than the total number of different position parameters included in the uncompressed representation of the scene.

The computer implemented method may further comprise: sampling the plurality of different position parameters to determine a second subset of the plurality of position parameters; and storing the second subset of the plurality of position parameters and the measures of the property of the scene corresponding to the second subset of the plurality of position parameters in addition to the first subset of the plurality of position parameters and the measures of the property of the scene at the first subset of the plurality of position parameters as a compressed representation of the scene.

Sampling the plurality of different position parameters may comprise performing a random sampling process. Sampling the plurality of different position parameters may comprise sampling the different position parameters at uniform intervals. Sampling the plurality of different position parameters may comprise sampling position parameters which lie in intervals between the detected first subset of the plurality of position parameters.

Sampling the plurality of different position parameters and further including the second subset of the plurality of position parameters and the measures of the property of the scene corresponding to the second subset of position parameters may provide further information regarding the property of the scene in spatial regions between discontinuities in the measures of the property. For example, the additional sampling may provide information regarding the shape and/or gradient of variations in the measures of the property in spatial regions between discontinuities in the measures of the property. Such additional information may improve the accuracy with which a decompression of the compressed representation matches the original representation.

According to a second aspect of the present disclosure there is provided a computer implemented method of decompressing a compressed representation of a three-dimensional scene, the compressed representation comprising first measures of a property of the scene corresponding to a plurality of first position parameters indicative of first positions in the scene, the method comprising; determining second measures of the property of the scene corresponding to a plurality of second position parameters indicative of second positions in the scene, wherein determining the second measures of the property of the scene corresponding to the plurality of second position parameters comprises, for each second position parameter: determining a subset of the plurality of first position parameters which are indicative of first positions which are located in proximity to the second position indicated by the second position parameter; and interpolating the first measures of the property of the scene corresponding to the determined subset of the plurality of first parameters to determine a second measure of the property of the scene corresponding to the second position parameter; and forming a decompressed representation of the three-dimensional scene, the decompressed representation comprising the first measures of the property of the scene corresponding to the plurality of first position parameters and the determined second measures of the property of the scene corresponding to the plurality of second position parameters.

In some examples, each of the plurality of first position parameters may fully define the three-dimensional position of the first position indicated by the first position parameter. Similarly, each of the plurality of second position parameters may fully define the three-dimensional position of the second position indicated by the second position parameter

In at least some examples, each of the plurality of first position parameters may define the first position indicated by the first position parameter in one or two dimensions. Similarly, each of the plurality of second position parameters may define the second position indicated by the second position parameter in one or two dimensions

Each of the position parameters may be indicative of a position in two dimensions. For example, the first and second measures of a property of the scene may correspond with a plurality of different two-dimensional positions in the scene. Each position parameter may comprise a set of two co-ordinates. The two co-ordinates in each set of two co-ordinates may relate to two different dimensions. That is, each position parameter may be expressed as a set of two-dimensional co-ordinates. For example, each measure of the property of the scene may be associated with a different set of two-dimensional co-ordinates. A set of two-dimensional co-ordinates may, for example, include a position on an x-axis and a position on a y-axis (or equivalently a position on a u-axis and a position on a v-axis). The position on the x-axis and the position on the y-axis may correspond to positions of pixels in an image to be rendered based on the representation of the three-dimensional scene. Equivalently, the position on the x-axis and the position on the y-axis may correspond respectively to viewing angles or directions in two-dimensions from a viewing position. The viewing position may represent a viewing position relative to which an image is to be rendered based on the representation of the three-dimensional scene.

In at least some examples, the property of the scene may comprise a position in a third dimension and the first and second measures of the property of the scene may comprise a position of a feature (such as a surface) in the scene in the third dimension. In at least some examples, the position in a third dimension may be expressed as a distance from a viewing position.

The property of the scene may be a property of surfaces in the scene. For example, the property of the scene may relate to geometry, material properties and/or optical properties of surfaces in the scene. The property of the scene may additionally or alternatively relate to lighting, illumination and/or shadowing properties of a scene expressed as a function of position parameters.

In at least some examples, the first and second measures of a property of the scene corresponding to the plurality of first position parameters and plurality of second position parameters respectively, may be expressed as an image. For example, each measure of the property of the scene may be expressed as a pixel brightness and the position parameter to which the measure corresponds may determine the position in the image at which the measure is expressed as a pixel brightness. The compressed representation of the scene may correspond with only a portion of the pixels of the image. The method of decompressing the compressed representation may allow the full image to be reconstructed. That is, the second measures of the property of the scene corresponding to the plurality of second position parameters may be thought of as the pixels of the image which are missing in the compressed representation.

The decompressed representation of the three-dimensional scene may be suitable for use in rendering an image of the scene. That is, the property of the scene may be a property which is used to render an image of the three-dimensional scene. The plurality of first position parameters and the plurality of second position parameters may correspond with different pixels in an image rendered based on the representation of the scene. The first position parameters included in the compressed representation may correspond with a first portion of the pixels of the image to be rendered. The second position parameters may correspond with a remaining portion of the pixels of the image to be rendered for which measures of the property of the scene are not included in the compressed representation. The method of decompression serves to determine measures of the property of the scene for the remaining pixels of the image to be rendered such that measures of the property are available for all pixels.

Each second position may represent a position in a parameter space for which a measure of the property of the scene should be determined. For example, the parameter space may represent a range of discrete viewing directions from a viewing position for which a measure of the property of the scene should be determined (e.g. in order to render an image of the scene). The range of discrete viewing directions may correspond with pixels of an image to be rendered. The first positions and the first position parameters may comprise a portion of the range of discrete viewing directions. The second positions and the second position parameters may comprise the remaining viewing directions included in the range of discrete viewing directions. That is, the second positions and second position parameters may comprise the viewing directions included in the range of discrete viewing directions to which none of the first position parameters correspond.

The subset of the plurality of first position parameters which are indicative of first positions which are located in proximity to the second position indicated by the second position parameter may comprise firsts positions which are located in proximity to the second position in the parameter space defined by the position parameters. For example, as was explained above, each of the position parameters may define a position in one, two or three dimensions. In examples, in which the position parameters define a position in two dimensions, the determining the subset of the plurality of first position parameters may comprise determining a subset of the first positions which are located in proximity to the second position in the two-dimensions which are defined by the position parameters. For example, where the position parameters relate to different viewing directions from a viewing position, first positions corresponding to viewing directions which are in proximity to the viewing direction to which the second position corresponds may be determined. Similarly, where the position parameters relate to positions of pixels in a two-dimensional pixel array (which may be defined by x and y-positions) first positions corresponding to pixel positions which are in proximity to the pixel position to which the second position corresponds may be determined.

In examples in which the position parameters define a position in three dimensions, the determining the subset of the plurality of first position parameters may comprise determining a subset of the first positions which are located in proximity to the second position in three-dimensional space.

Determining a subset of the plurality of first position parameters which are indicative of first positions which are located in proximity to the second position indicated by the second position parameter may comprise determining a subset of first positions which are closest to the second position (in the parameter space defined by the position parameters). For example, first positions may be determined whose distance from the second position (in the parameter space defined by the position parameters) is less than distances from the second position of others of the plurality of first position parameters. In other words, determining the subset of the plurality of first position parameters may comprise determining first positions which are nearest neighbours of the second position (in the parameter space defined by the position parameters).

Interpolating the first measures of the property of the scene corresponding to the subset of the plurality of first parameters to determine a second measure of the property of the scene corresponding to the second position parameter may comprise determining the second measure of the property of the scene in dependence on the subset of the plurality of first parameters, the second position parameter and the first measures of the property of the scene corresponding to the subset of the plurality of first parameters. For example, some form of function (e.g. a linear function) may be fitted to the subset of the plurality of first parameters and the first measures of the property of the scene corresponding to the subset of the plurality of first parameters. The fitted function may be used to determine a second measure of the property of the scene based on the second position parameter.

The first measures and determined second measures of a property of the scene may comprise measures of a property of surfaces in the scene corresponding to the plurality of first and second position parameters respectively.

The property may, for example, relate to material and/or optical properties of surfaces in the scene expressed at the plurality of different position parameters. For example, the measures of the property of the scene may be indicative of a reflectivity of surfaces in the scene and may, for example, be expressed as an albedo. A measure of reflectively and/or albedo may, for example, be expressed for a plurality of different colours (e.g. red, green and blue). In at least some examples, the measures of the property of the scene may comprise at least one of a red albedo, a blue albedo and a green albedo.

In a least some examples, the measures of the property of the scene may be indicative of optical distortion of surfaces in the scene. In at least some examples, the measures of the property of the scene may be indicative of a colour of surfaces in the scene.

The measures of a property of surfaces in the scene may comprise measures indicative of geometry of surfaces in the scene.

For example, the property may relate to the position, shape and/or orientation of surfaces in the scene. In at least some examples, the property may relate to a distance of surfaces from a reference position or plane (e.g. a viewing position). In at least some examples, the property may relate to an orientation of surfaces in the scene. The orientation of surfaces may, for example, be expressed as a direction of a surface normal. The measures of a property of the scene may, for example, comprise measures of surface normal directions corresponding to a plurality of different position parameters (which may for example, relate to different pixels in an image to be rendered or equivalently different viewing directions from a viewing position).

The plurality of first position parameters and the plurality of second position parameters may correspond with a plurality of different viewing directions originating at a viewing position. Each of the first measures and second measures of a property of the scene may correspond with a viewing direction of the plurality of viewing directions.

The plurality of different viewing directions may equivalently be thought of as a plurality of different rays, each passing through the viewing position. The plurality of different rays may, for example, correspond with rays in rendering techniques such as ray casting.

The plurality of different viewing directions may be characterised in two dimensions. For example, the plurality of different viewing directions may relate to different positions on an x and y-axis. The x and y-axis may directly relate to positions of pixels in an image to be rendered based on the representation of the scene. Additionally or alternatively, the plurality of different viewing directions may be expressed as different angles of the viewing directions originating from the viewing position. Each viewing direction may be expressed as angles in two-dimensions relative to some reference direction. For example, each viewing direction may be expressed as a polar angle and an azimuthal angle.

The compressed representation of the three-dimensional scene may comprise a portion of a depth map. The first and second measures of the property of the scene comprise distances to a surface in the three-dimensional scene along the plurality of different viewing directions from the viewing position.

The distances may comprise a distance to a closest surface in the scene from the viewing position and along the respective viewing direction. For example, the distances may be thought of as a distance along a ray originating at the viewing position and extending in the respective viewing direction, the distance being the distance along the ray until the ray first intercepts a surface in the scene.

In at least some examples, the distances may additionally or alternatively comprise at least some distances to an occluded surface in the scene, when viewed from the viewing position. For example, at least some distances may comprise a distance to a second, third or subsequent surface which is intercepted by a ray originating from the viewing position and extending in the respective viewing direction.

Interpolating the first measures corresponding to the subset of the plurality of first parameters to determine a second measure of the property of the scene corresponding to the second position parameter may comprise linear interpolation.

Interpolating the first measures corresponding to the subset of the plurality of first parameters to determine a second measure of the property of the scene corresponding to the second position parameter may comprise: determining weights associated with each of the subset of the plurality of first position parameters in dependence on distances between the first positions indicated by the first position parameters and the second position indicated by the second position parameter; and determining a weighted average of the first measures of the property of the scene corresponding to the subset of the plurality of first parameters. The weighted average may be determined using the determined weights associated with each of the subset of the plurality of first position parameters.

Distances between the first positions indicated by the first position parameters and the second position indicated by the second position parameter may comprise distances in the parameter space defined by the position parameters. For example, where the position parameters define a position in two dimensions, the distances between the first positions and the second position may comprises distances in the two-dimensional space. Where the position parameters define a position in three dimensions, the distances between the first positions and the second position may comprises distances in three-dimensional space.

First positions which have smaller distances to the second position may be assigned with larger weights that first positions which have larger distances to the second position. For example, the determined weights may be inversely proportional to the distances between the first positions and the second position. That is, measures of the property of the scene corresponding to first positions which are closer to the second position may have a greater influence on the determined second measure of the property of the scene corresponding to the second position parameter.

Interpolating the first measures corresponding to the subset of the plurality of first parameters to determine a second measure of the property of the scene corresponding to the second position parameter may comprise performing an inverse distance weighting.

Determining a subset of the plurality of first position parameters which are indicative of first positions which are located in proximity to the second position indicated by the second position parameter may comprise: dividing a parameter space characterised by the first position parameters into a plurality of segments in which each of the first position parameters fall; identifying at least one proximate segment in which the second position parameter falls and/or which neighbours a segment in which the second position parameter falls; and determining the subset of the plurality of first position parameters as at least some of the plurality of first position parameters which are situated in the at least one proximate segment.

As was explained above, the position parameters may define a position in one dimension, two dimensions or three dimensions. The parameter space characterised by the first position parameters may therefore comprise a corresponding parameter space in one, two or three dimensions. For example, where the position parameters define a position in two dimensions, the parameter space is a corresponding two-dimensional parameter space. Where the position parameters define a position in three dimensions, the parameter space is a corresponding three-dimensional parameter space.

In some examples, the second position parameter may be situated in (fall within) a segment of the parameter space which includes one or more of the plurality of first position parameters. In such examples, the at least one proximate segment may be identified to include the same segment in which the second position parameter falls. In some examples, at least one proximate segment may be identified to include at least one segment which neighbours the same segment in which the second position parameter falls.

Determining the subset of the plurality of first position parameters as at least some of the plurality of first position parameters which are situated in the at least one proximate segment may comprise selecting all of the first position parameters which are situated in the at least one proximate segment. Alternatively, determining the subset of the plurality of first position parameters as at least some of the plurality of first position parameters which are situated in the at least one proximate segment may comprise selecting one or more first position parameter in each of the proximate segments (e.g. the first position parameter in each proximate segment representing the closest position to the second position).

Dividing the parameter space characterised by the first position parameters into a plurality of segments in which each of the first position parameters fall may comprise at least one of: determining a plurality of Voronoi cells based on the plurality of first position parameters as seeds; constructing a k-d tree based on the plurality of first position parameters; and dividing the parameter space into uniform segments.

The methods of the first and/or second aspects may be implemented on at least one graphics processing unit.

Each of the method steps may be implemented on at least one graphics processing unit. A graphic processing unit may comprise a plurality of processing cores. Aspects of one or more of the method steps may be implemented on different processing cores and in parallel with each other. In some examples, one or more of the method steps may be implemented on a plurality of graphical processing units. For example, one or more of the method steps may be implemented on a plurality of graphical processing units operating in parallel with each other.

The methods of compression and decompression disclosed herein are particularly suitable for parallelisation. For example, the detection of a first subset of the plurality of position parameters, which are indicative of positions of discontinuities in the measures of the property of the scene (as performed as part of a compression method) is a task which may be easily parallelised to allow a plurality of cores and/or a plurality of processing units (e.g. graphics processing units) to perform portions of the detection in parallel. For example, different portions of the parameter space may be analysed by different cores and/or processing units to identify different discontinuities in parallel.

Furthermore, determining a subset of the plurality of first position parameters which are indicative of first positions which are located in proximity to the second position indicated by the second position parameter (as performed as part of a decompression method), is a task which may be easily parallelised to allow a plurality of cores and/or a plurality of processing units (e.g. graphics processing units) to perform determinations of subsets in parallel. For example, different subsets associated with different second positions may be determined by different cores and/or processing units in parallel.

Furthermore, interpolating the first measures of the property of the scene corresponding to the subset of the plurality of first parameters to determine a second measure of the property of the scene corresponding to the second position parameter as performed as part of a decompression method), is a task which may be easily parallelised to allow a plurality of cores and/or a plurality of processing units (e.g. graphics processing units) to perform interpolations in parallel. For example, second measures of the property of the scene corresponding to different second position parameters may be determined by different cores and/or processing units in parallel.

According to a third aspect of the present disclosure there is provided a method of distributing a representation of a three-dimensional scene, the method comprising: compressing a representation of a three-dimensional scene according to a method of the first aspect and performed by at least one first computing apparatus; transmitting the compressed representation of the three-dimensional scene to at least one second computing apparatus; and decompressing the compressed representation of the three-dimensional scene according to a method of the second aspect performed by the at least one second computing apparatus.

The method may further comprise: rendering, at the at least one second computing apparatus, an image of the three-dimensional scene using the decompressed representation of the three-dimensional scene.

According to a fourth aspect of the present disclosure there is provided a computer implemented method of rendering an image for display, the method comprising: decompressing a compressed representation of a three-dimensional scene according to a method of the second aspect; and rendering an image of the three-dimensional scene using the decompressed representation of the three-dimensional scene.

According to a fifth aspect of the present disclosure there is provided a computer implemented method of compressing a depth map representing surfaces in a three-dimensional scene, wherein the depth map comprises a plurality of distances from a viewing position to a surface in the three-dimensional scene, the plurality of distances corresponding to different viewing directions from the viewing position, the method comprising: detecting a first subset of the viewing directions which represent viewing directions along which discontinuities in the plurality of distances corresponding to different viewing directions occur; and storing the first subset of viewing directions and the distances associated with the first subset of viewing directions as a compressed depth map.

According to a sixth aspect of the present disclosure there is provided a computer implemented method of decompressing a compressed depth map representing surfaces in a three-dimensional scene, the compressed depth map comprising a first plurality of distances from a viewing position to a surface in the three-dimensional scene along a first plurality of viewing directions from the viewing position, the method comprising: determining a second plurality of distances, based on the first plurality of distances, the second plurality of distances being from the viewing position to a surface in the three-dimensional scene along a second plurality of viewing directions, wherein determining the second plurality of distances comprises, for each viewing direction of the second plurality of viewing directions: determining a subset of the first plurality of viewing directions which are in proximity to the viewing direction of the second plurality of viewing directions; and interpolating the first plurality of distances being along the subset of the first plurality of viewing directions to determine a distance to a surface in the three-dimensional scene along the viewing direction of the second plurality of viewing directions; and forming a decompressed depth map, the decompressed depth map comprising the first plurality of distances and the determined second plurality of distances.

According to a seventh aspect of the present disclosure there is provided a computing apparatus configured to compress a representation of a three-dimensional scene, wherein the representation comprises measures of a property of the scene corresponding to a plurality of different position parameters indicative of positions in the scene, the computing apparatus comprising: at least one processing unit; memory storing instructions which, when executed by the one or more processors, cause the apparatus to: detect a first subset of the plurality of position parameters, which are indicative of positions of discontinuities in the measures of the property of the scene; and store the first subset of the plurality of position parameters and the measures of the property of the scene corresponding to the first subset of the plurality of position parameters as a compressed representation of the scene.

The at least one processing unit may comprise at least one graphics processing unit. The instructions may be configured for execution by the at least one graphics processing unit.

According to an eight aspect of the present disclosure there is provided a computing apparatus configured to decompress a compressed representation of a three-dimensional scene, the compressed representation comprising first measures of a property of the scene corresponding to a plurality of first position parameters indicative of first positions in the scene, the computing apparatus comprising: at least one processing unit; memory storing instructions which, when executed by the one or more processors, cause the apparatus to: determine second measures of the property of the scene corresponding to a plurality of second position parameters indicative of second positions in the scene, wherein determining the second measures of the property of the scene corresponding to the plurality of second position parameters comprises, for each second position parameter: determining a subset of the plurality of first position parameters which are indicative of first positions which are located in proximity to the second position indicated by the second position parameter; and interpolating the first measures of the property of the scene corresponding to the determined subset of the plurality of first parameters to determine a second measure of the property of the scene corresponding to the second position parameter; and form a decompressed representation of the three-dimensional scene, the decompressed representation comprising the first measures of the property of the scene corresponding to the plurality of first position parameters and the determined second measures of the property of the scene corresponding to the plurality of second position parameters.

The at least one processing unit may comprise at least one graphics processing unit. The instructions may be configured for execution by the at least one graphics processing unit.

According to a ninth aspect of the present disclosure there is provided a computing apparatus configured to compress a depth map representing surfaces in a three-dimensional scene, wherein the depth map comprises a plurality of distances from a viewing position to a surface in the three-dimensional scene, the plurality of distances corresponding to different viewing directions from the viewing position, the computing apparatus comprising: at least one processing unit; memory storing instructions which, when executed by the one or more processors, cause the apparatus to: detect a first subset of the viewing directions which represent viewing directions along which discontinuities in the plurality of distances corresponding to different viewing directions occur; and store the first subset of viewing directions and the distances associated with the first subset of viewing directions as a compressed depth map.

According to a tenth aspect of the present disclosure there is provided a computing apparatus configured to decompress a compressed depth map representing surfaces in a three-dimensional scene, the compressed depth map comprising a first plurality of distances from a viewing position to a surface in the three-dimensional scene along a first plurality of viewing directions from the viewing position, the computing apparatus comprising: at least one processing unit; memory storing instructions which, when executed by the one or more processors, cause the apparatus to: determine a second plurality of distances, based on the first plurality of distances, the second plurality of distances being from the viewing position to a surface in the three-dimensional scene along a second plurality of viewing directions, wherein determining the second plurality of distances comprises, for each viewing direction of the second plurality of viewing directions: determining a subset of the first plurality of viewing directions which are in proximity to the viewing direction of the second plurality of viewing directions; and interpolating the first plurality of distances being along the subset of the first plurality of viewing directions to determine a distance to a surface in the three-dimensional scene along the viewing direction of the second plurality of viewing directions; and form a decompressed depth map, the decompressed depth map comprising the first plurality of distances and the determined second plurality of distances.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF FIGURES

One or more embodiments of the invention are shown schematically, by way of example only, in the accompanying drawings, in which:

FIG. 1 is a schematic illustration of a system for producing, rendering and displaying an image of a three-dimensional scene;

FIG. 2 is a schematic depiction of a depth map of an example three-dimensional scene;

FIG. 3 is a flow chart of a method of compressing a representation of a three-dimensional scene;

FIG. 4 is a schematic depiction of determined second derivatives of the depth map of FIG. 2;

FIG. 5 is a flow chart of a method of decompressing a compressed representation of a three-dimensional scene;

FIG. 6 is a schematic illustration of a parameter space divided into segments and a plurality of first positions in the parameter space;

FIG. 7 is a schematic illustration of a parameter space divided into Voronoi cells and a plurality of first positions in the parameter space;

FIG. 8 is a schematic illustration of a parameter space divided into a plurality of segments with respect to a target second position and a plurality of first positions in the parameter space;

FIG. 9 is a schematic illustration of a subset of first positions used to determine a measure of a property of a three-dimensional scene for a second position;

FIG. 10 is a schematic illustration of a portion of the depth map of FIG. 2 in its original uncompressed form and having been compressed and decompressed using two different methods; and

FIG. 11 is a schematic illustration of a computing device which may be used to implement aspects of one or more methods described herein.

### DETAILED DESCRIPTION

Before particular examples of the present invention are described, it is to be understood that the present disclosure is not limited to the particular examples described herein. It is also to be understood that the terminology used herein is used for describing particular examples only and is not intended to limit the scope of the claims.

In describing and claiming the computing apparatus and methods of the present invention, the following terminology will be used: the singular forms “a”, “an”, and “the” include plural forms unless the context clearly dictates otherwise. Thus, for example, reference to “a processing unit” includes reference to one or more of such elements.

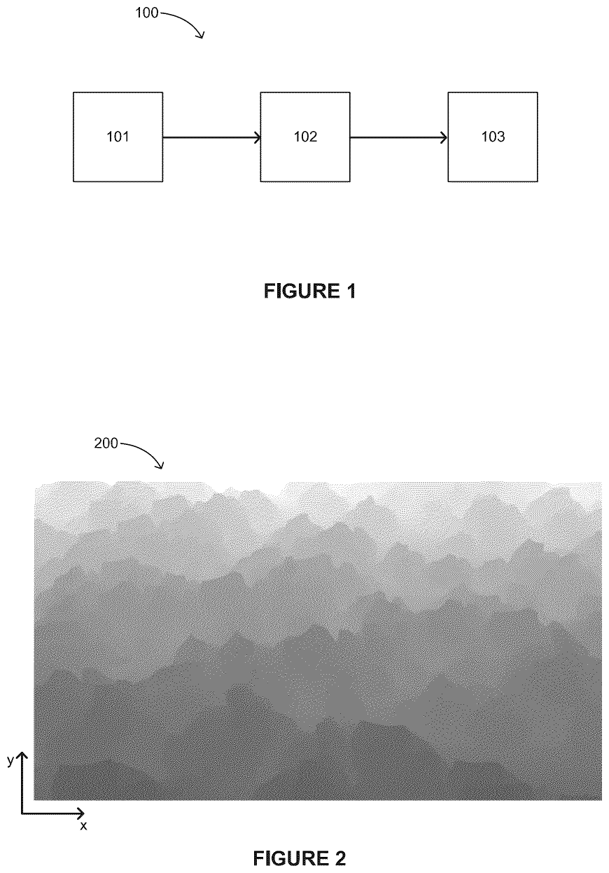

FIG. 1 is a schematic illustration of a system 100 for producing, rendering and displaying an image of a three-dimensional scene. The system 100 includes a media server 101, a rendering module 102 and a display device 103. The media server 101 may generate, receive or store information characterising a three-dimensional scene to be displayed by the display device 103. In at least some examples, the three-dimensional scene may include a virtual component, for example, for displaying as part of an extended reality (XR) experience. The three-dimensional scene may be represented by a plurality of components which allow the scene to be rendered for display. For example, representation of a three-dimensional scene may comprise components which characterise properties such as geometry, material properties, viewpoint, texture, lighting and shading information which fully describe the scene to be displayed in sufficient detail to allow an image of the scene to be rendered. This information may be generated at the media server 101, may be received at the media server 101 and/or may be stored at the media server 101.

A representation of a three-dimensional scene for use in rendering may comprise measures of a property of the scene corresponding to a plurality of different position parameters indicative of positions in the scene. That is, a given property of the scene may be expressed for a plurality of different positions in the scene. The property of the scene may comprise a property related to surfaces in the scene. For example, the property may be indicative of the geometrical properties, such as position, shape and/or orientation (e.g. surface normal directions) of surfaces in the scene. Additionally or alternatively the property may be indicative of surface properties such as material and/or optical properties of surfaces. For example, properties such a surface reflectivity (which might, for example, be expressed as an albedo for one or more colours), distortion, and/or colour may be represented as a function of position in the scene. Additionally or alternatively, one or more properties indicative of lighting, illumination and/or shadows in the scene may be represented as a function of position in the scene. In general, any property which may be used to render an image of a scene may be represented as measures of a property of the scene corresponding to a plurality of different position parameters indicative of positions in the scene.

The plurality of different position parameters which are indicative of different positions in the scene may each comprise one or more co-ordinates defining a position in one or more dimensions. For example, each different position parameter may comprise a set of co-ordinates defining a position in the scene in two or three dimensions. In such examples, the measures of the property of the scene may be expressed for a plurality of different two or three-dimensional positions in the scene.

A two-dimensional position in a three-dimensional scene may be defined as a position on an x-axis and a position on a y-axis. The position on the x-axis and the position on the y-axis may correspond to positions of pixels in an image to be rendered based on the representation of the three-dimensional scene. Equivalently, the position on the x-axis and the position on the y-axis may correspond respectively to viewing angles or directions in two-dimensions from a viewing position. The viewing position may represent a viewing position relative to which an image is to be rendered based on the representation of the three-dimensional scene. In at least some examples, the property of the scene may comprise a position in a third dimension expressed at a plurality of different position parameters which define a position in two-dimensions.

In order to aid understanding of scene representations which are contemplated herein, an example of a representation in the form of a depth map will be described and depicted in detail. However, it should be understood that the methods and features described herein may also be applicable for other forms of representation for different properties to those described in detail herein.

A depth map represents distances from a viewing position to surfaces in a three-dimensional scene as viewed along different viewing directions. The different viewing directions may be thought of as different rays (characterised by a straight line) each passing through the viewing position. For example, the different viewing directions may correspond with rays used to render the scene to form an image (e.g. when using rendering techniques such as ray casting).

The distances corresponding to different viewing directions are an example of measures of a property (distance to surfaces) corresponding to a plurality of different position parameters (different viewing directions). The distances corresponding to different viewing directions can be visualised as a greyscale image. Different viewing directions represented by the depth map may correspond to different pixels of a rendered image to be displayed by the display device 103. That is, pixels of a depth map may directly correspond to pixels of an image to be rendered using the depth map.

FIG. 2 is a schematic illustration of a depth map 200 of an example three-dimensional scene. The example depth map is illustrated in FIG. 2 as a greyscale image. Each pixel of the grayscale image is presented at a different position on x and y-axes which are labelled in FIG. 2 (equivalently u and v axes could be used to denote the position in two-dimensions). Different positions on the x and y-axes represent different viewing directions relative to a reference viewing position. The greyscale intensity of each pixel represents a distance from the viewing position to a surface in the three-dimensional scene along the viewing direction to which the pixel corresponds. For example, surfaces closer to the viewing position may be displayed as darker shades and surfaces further away from the viewing position may be displayed as lighter shades.

A depth map may be stored as a two-dimensional array of distances from a viewing position to a surface in a three-dimensional scene. Different positions in the two-dimensional array may represent different viewing directions from the viewing position. For example, different columns in the two-dimensional array may correspond to different positions on an x-axis (for example, the x-axis shown in FIG. 2) and different rows in the two-dimensional array may correspond to different positions on a y-axis (for example, the y-axis of FIG. 2).

A depth map defines the positions of surfaces using a form of three-dimensional co-ordinate system. The distances stored in the depth map as measures of a property (distance) represent one dimension of the co-ordinate system. The two dimensions which define where in the depth map (e.g. the column number and the row number or equivalently the x and y position) the distances are stored represent the remaining two dimensions of the co-ordinate system. The two dimensions which define where in the depth map the distances are stored correspond with two dimensions which define a viewing direction from a viewing position and may be thought of as a plurality of different position parameters to which each distance corresponds.

In at least some examples, a depth map representing surfaces in a three-dimensional scene may be generated from an alternative representation of the surfaces in the three-dimensional scene. For example, surfaces of a three-dimensional scene may be represented by a collection of polygons forming surfaces in the three-dimensional scene. A depth map may be generated (e.g. by the media server 101) relative to a defined viewing position, the depth map being generated by calculating distances from the viewing position to surfaces in the three-dimensional scene along different viewing directions.

As was explained above, a representation of a property of a three-dimensional scene (such as a depth map) may be used to render an image of the scene for display. In at least some examples, a plurality of different representations each related to a different property may be used to render an image of the scene. Different properties (e.g. related to the geometry and/or material/optical properties of surfaces) may each be expressed as measures of a given property corresponding to a plurality of different position parameters. The plurality of different position parameters may be the same for one or more different properties. For example, a plurality of different representations each related to a different property may comprise measures of the various properties corresponding to the same range of viewing directions from a viewing position (or equivalently pixel positions in an image to be rendered).

Such representations of the one or more properties of a scene corresponding to different position parameters, along with further information characterising the scene, may be provided to the rendering module 102 from the media server 101. The rendering module 102 may use the information provided to it by the media server 101 (including the one or more representations of the scene, such as a depth map) to render an image of the three-dimensional scene for display by the display device 103. For example, the rendering module 102 may perform deferred rendering to produce an image for display. The rendered image for display may be represented by brightness values for one or more colours and corresponding to a plurality of pixels.

The display device 101 may be any suitable form of display such as one or more two-dimensional displays, three-dimensional displays and/or projectors.

An image which is rendered by the rendering module 102 for display by the display device 103 may represent a frame of moving visual media (e.g. video). Moving visual media may be displayed by the display device at a frame rate of several frames per second (e.g. tens of frames per second such as 60 frames per second). That is, the display device 103 may display several different images (representing frames of moving visual media) per second.

In at least some examples, images for display by the display device 103 may be rendered in real time. That is, the rendering module 102 may render images at a corresponding frame rate (e.g. several tens of frames per second) to the frame rate at which frames are displayed by the display device 103.

In at least some examples, the three-dimensional scene to be rendered and displayed may also be generated in real-time. For example, the media server 101 (or other module) may generate a three-dimensional scene to be rendered and displayed at a corresponding frequency to the frame rate at which frames are rendered and displayed by the rendering module 102 and the display device 103. This may in particular be the case where the three-dimensional scene to be rendered and/or the image to be displayed is responsive to some real-time input.

The functionality of a media server 101, rendering module 102 and/or display device 103 may be performed by different devices, as is schematically illustrated in the system 100 of FIG. 1. However, in some examples, at least some functionality of a media server 101, a rendering module 102 and/or a display device may be realised by a single device. That is some aspects of a media server 101, a rendering module 102 and/or a display device 103 may be realised in a single device. In some examples, functionality of a media server 101, a rendering module 102 and/or a display device 103 may be distributed across a plurality of devices. For example, a rendering module 102 may comprise a distributed rendering system comprising a plurality of devices connected over a network. Different devices in the distributed rendering system may perform aspects of a rendering task in parallel (e.g. distributed devices may render different portions of a frame in parallel). A distributed rendering system may provide improvements in rendering speed (relative to rendering being performed by a single device), which may be of particular importance when performing real-time rendering.

It will be appreciated that when using a plurality of devices to realise a system 100 for producing, rendering and displaying an image of a three-dimensional scene, one or more representations of the scene may need to be communicated between devices, for example, over a network. For example, at least one representation of a property of a scene (such as a depth map) may be generated and/or stored at the media server 101 and may be transmitted to a rendering module 102 for use in rendering an image. Additionally or alternatively, a representation of a property of a scene may be communicated between different devices which form a distributed rendering system.

The transmission of one or more representations of a scene (such as a depth map) between devices and over a network may use significant amounts of bandwidth. Taking the example of a depth map, in order to retain sufficient accuracy in rendering based on a depth map, it may be desirable to retain a relatively large bit-depth to represent the distances in the depth map. For example, each distance may be stored at a bit-depth of 24 or 32 bits. When rendering, for example, images at 4k or Ultra High Definition (UHD) resolutions a single depth map may represent up to approximately 32 megabytes worth of data. For real-time rendering applications it may be required to transmit several tens of depth maps per second corresponding to several tens of frames of a moving image per second (e.g. 60 frames per second) over a network. At a frame rate of 60 frames per second, transmitting depth maps corresponding to 4k or UHD resolutions may require a network bandwidth of nearly 2 gigabytes per second for transmission of the depth maps alone. Furthermore, modern distributed rendering tasks are reaching resolutions of 8k, 12k and higher further increasing the network bandwidth needed for real-time rendering applications.

Whilst example bandwidths have been provided above for the transmission of depth maps in real-time rendering applications, as was further explained above, one or more further representations of properties of a three-dimensional scene may also be used for rendering images. Such representations may each include measures of a property of the scene for a similar number of position parameters (pixels) as a depth map and may also require transmission at a corresponding frame rate. Such further representations of properties of a three-dimensional scene therefore also require significant amounts of network bandwidth for real-time rendering applications.

In order to reduce network bandwidth requirements, it is often desirable to compress a representation of a three-dimensional scene (such as a depth map) so as to generate a compressed representation having a smaller memory footprint than the original uncompressed representation. A compressed representation of the scene can then be transmitted over a network using less network bandwidth then transmitting the original uncompressed representation. For example, in the system of FIG. 1, the media server 101 may compress a representation of a three-dimensional scene (such as a depth map) and transmit a compressed representation to the rendering module 102. The rendering module 102 may decompress the compressed representation to produce a decompressed representation, which as far as possible replicates the original uncompressed representation. The rendering module 102 may use the decompressed representation to render an image of the scene.

Advantages of compressing and decompressing a representation of a three-dimensional scene have been described above in the context of real-time rendering applications in terms of reducing a network bandwidth required to transmit a representation of a scene. However, compressing and decompressing representations of a scene may have further advantages which go beyond a reduction in network bandwidth and which may not be limited to real-time rendering applications. For example, compression of a representation of a scene may be used simply to reduce a memory footprint required to store the representation. For example, a representation of a scene could be generated in advance and stored in memory until it is used. In such instances compression of the representation prior to storage can reduce the memory footprint required to store the representation.

Possible methods of compressing a representation of a three-dimensional scene include known image compression methods. For example, image compression used in video encoding methods (e.g. video encoding standards such as the H.264 standard) could be used to compress a representation of a three-dimensional scene. However, it has been found that common image compression methods are often ill-suited to compression of a representation of a three-dimensional scene.

In particular, it has been realised that the information included in representations of a property of a scene can often be characterised by low frequency information and higher frequency information can be discarded. For example, properties of a scene often undergo sharp transitions (discontinuities) as a function of position at the edges of objects and are either relatively constant and/or have a relatively constant rate of change in locations between the transitions. Taking the depth map depicted in FIG. 2 as an example, it can be seen that the depths represented in the depth map undergo several discontinuities which may represent transitions between objects or different surfaces of an object. Many image compression methods (such as those commonly used in video encoding standards) utilise macroblock encoding. It has been found that such macroblock encoding often degrades discontinuities in the compression process and may therefore lead to a loss of information.

The methods described herein have been found to be particularly advantageous for the compression of representations of a three-dimensional scene, such as a depth map. For example, the compression and decompression methods described herein may be capable of achieving relatively high compression ratios with relatively low loss of information. Furthermore, the compression and decompression methods described herein are particularly suitable for parallelisation such that multiple processing cores and/or processing units may carry out parts of the compression and decompression methods in parallel. This may allow the methods to be implemented entirely on one or more graphics processing units (GPUs) and allow for full GPU parallelisation. The methods described herein may therefore allow compression and decompression speeds sufficient for real-time rendering applications to be achieved.

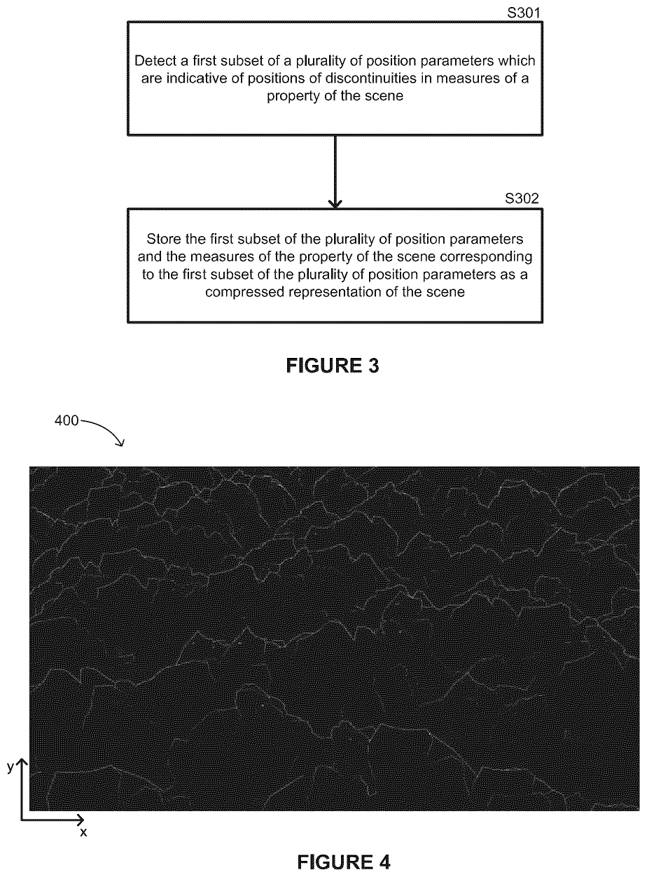

FIG. 3 is a flowchart of a method of compressing a representation of a three-dimensional scene. The method may be implemented on any suitable computing device or apparatus. For example, the method may be implemented by the media server 101 of FIG. 1. In at least some examples, the method may be implemented using a graphics processing unit (GPU).

As was explained above, a representation of a three-dimensional scene may comprise measures of a property of the scene corresponding to a plurality of different position parameters indicative of positions in the scene. The different position parameters indicate different positions in a parameter space defined by the position parameters. For example, a position parameter may relate to a pixel location in an image to be rendered, which may equivalently be thought of as a viewing direction from a viewing position, relative to which the image is to be rendered. An example representation used to describe the method of FIG. 3 is a depth map, in which the measures of a property of the scene comprise distances from a viewing position to surfaces in the scene and the plurality of different position parameters comprise different viewing directions from the viewing position (or equivalently pixel positions in an image to be rendered based on the depth map). An example depth map on which the method of FIG. 3 may be applied is depicted schematically in FIG. 2, as was described above. The methods described herein may also be applied to representations of other properties of a three-dimensional scene.

At step 301 of FIG. 3 a first subset of the plurality of position parameters are detected. The detected first subset of the plurality parameters are indicative of positions of discontinuities in the measures of the property of the scene. The detected first subset of the plurality of position parameters may represent positions at which the measures of the property of the scene undergo discontinuities (e.g. sharp transitions, such as a step change) with changes in the position parameter (or equivalently changes in position in the parameter space defined by the position parameters). For instance, in examples in which the position parameters represent viewing directions from a viewing position and/or positions of pixels in an image, the discontinuity positions may represent positions at which discontinuities occur in the measures of the property of the scene between adjacent viewing directions and/or pixel positions.

Discontinuities in the measures of the property of the scene may be detected using any suitable technique. For example, one or more edge-detection techniques used in image processing applications may be used to locate discontinuities in the measures of the property of the scene.

In at least some examples, a measure of a derivative of the measures of the property of the scene with respect to changes in the position parameter may be determined. For example, a measure of a first derivative and/or a second derivate of the measures of the property of the scene with respect to changes in the position parameter may be determined. Taking the example, of a depth map (e.g. the depth map shown in FIG. 2), derivatives of the distances to a surface represented by the depth map as a function of changes in viewing direction (or equivalently pixel position) may be determined.

FIG. 4 is a schematic representation 400 of the second derivative of the depth map shown in FIG. 2 shown on the same x and y-axis used in FIG. 2. In the representation of FIG. 4, lighter shades are used to depict larger values of the absolute value (magnitude) of the second derivative and darker shades are used to depict smaller values of the absolute value of the second derivative. The computed second derivatives comprise a combination of the second derivative with respect to changes in the x-direction and the second derivative with respect to changes in the y-direction. In the particular example of FIG. 2, the second derivatives are determined by applying a Laplacian operator to the distances in the depth map as a function of changes in the x and y-position.

In at least some examples, derivatives (e.g. first or second derivatives) may be determined by performing a convolution of a representation of a scene with a kernel. For example, the second derivatives shown in FIG. 4 are determined by performing a convolution of the depth map of FIG. 2 and a Laplacian kernel. Any suitable kernels may be used to compute first or second derivates such as a Sobel kernel, Scharr kernel, Prewitt kernel and/or kernels for computing a difference of Gaussians.

As can be seen in FIG. 4, the absolute value of the second derivative of the depth map of FIG. 2 includes discrete regions in which the absolute second derivative is relatively high (the white lines which appear in FIG. 4) and large regions in which the absolute second derivative is relatively low (the dark regions between the white lines in FIG. 4). The discrete regions in which the second derivative is relatively high represent positions of discontinuities in the distances represented by the depth map (as can be seen by a comparison on FIGS. 2 and 4).

In at least some examples, a first subset of the plurality of position parameters may be determined as position parameters at which the magnitude of a determined derivative is greater than a derivative threshold. For example, positions in the image shown in FIG. 4 at which the second derivatives are greater than a second derivative threshold may be determined. That is, pixel positions on the x and y-axis (or equivalently viewing directions from a viewing position) may be determined at which the second derivatives are greater than a threshold. The position parameters corresponding to the positions at which the magnitude of the determined derivative is greater than the derivative threshold are determined as a first subset of the position parameters indicative of positions of discontinuities in the measures of the property of the scene.

The derivative threshold may be a pre-determined threshold and may, for example, remain constant for processing a plurality of different scenes. Alternatively, the derivative threshold may be determined in dependence on the scene representation which is being processed. For example, the derivative threshold may be determined in dependence on the number of position parameters at which the magnitude of the determined derivate is greater than the derivative threshold. For instance, it may be desirable to achieve a target compression ratio of, for example, 10:1. The derivative threshold may be determined such that, for example, the number of position parameters at which the magnitude of the determined derivates is greater than the derivative threshold is 10% or less of the total position parameters in order to achieve the target compression ratio. In other examples, different target compression ratios may be used to determine the derivative threshold.

At step 302 of FIG. 3, the first subset of the plurality of position parameters (determined at step 301) and the measures of the property of the scene corresponding to the first subset of position parameters are stored as a compressed representation of the scene. For example, for a depth map, a compressed representation of the depth map may comprise the pixel positions (or equivalently viewing directions) at which discontinuities were detected in the distances forming the depth map (the first subset of position parameters detected in step 301), along with the distances corresponding to the discontinuity positions. The compressed representation of the scene may be thought of as a portion of the original representation, wherein the portion is selected to correspond with discontinuities in the property of the scene.

In at least some examples, the compressed representation may comprise only the first subset of position parameters and the measures of the property of the scene corresponding to the first subset of position parameters. That is, the data points corresponding to discontinuities in the scene property may be the only data included in the compressed representation. In some examples, some additional metadata may be included in the compressed representation to assist with interpretation and decompression of the compressed representation.

In some examples, one or more further data points (in addition to those detected in step 301) may be included in the compressed representation. For example, the method of FIG. 3 may further comprise sampling the plurality of different position parameters to determine a second subset of the plurality of position parameters (in addition to the first subset detected at step 301). The sampling may comprise any suitable sampling method such as a random sampling method. Additionally or alternatively, the position parameters may be sampled at uniform intervals. For example, every nth pixel (where n in an integer) of a depth map (or other equivalent representation) in the x and/or y-direction may be sampled to determine the second subset of the plurality of position parameters. In some examples, regions of parameter space located in between position parameters in the first subset of position parameters may be sampled.

The second subset of the plurality of position parameters (determined through a sampling method) and the measures of the property of the scene corresponding to the second subset of position parameters may be included in the compressed representation of the scene. That is, the compressed representation may comprise the first subset of position parameters, the measures of the property of the scene corresponding to the first subset of position parameters, the second subset of position parameters and the measures of the property of the scene corresponding to the second subset of position parameters.

The second subset of position parameters (and the measures of the property of the scene corresponding to the second subset of position parameters) may be included in the compressed representation in order to provide information about the property of the scene in regions of parameter space in between the discontinuity positions. For example, sampling additional points to include in the second subset may provide information about the nature (e.g. shape, gradient etc.) of variations in the property of the scene in between the discontinuity positions (the first subset of position parameters). Including the second subset of position parameters and corresponding measures of the property of the scene in the compressed representation may therefore serve to improve the accuracy with which the original representation of the scene can be reproduced based on the compressed representation.

As was explained above, in at least some examples, additional data points (in addition to the detected first subset of position parameters corresponding to discontinuities) may be included in a compressed representation of the scene. For example, a second subset of the position parameters determined through sampling may also be included in the compressed representation. However, even in such examples, the compressed representation of the scene may be fully expressed as a subset of the plurality of different position parameters included in the uncompressed representation and the measures of the property of the scene corresponding to the subset of the plurality of different position parameters. The subset of the plurality of different position parameters includes at least the first subset detected at step 301. In at least some examples, the subset of the plurality of different position parameters which express the compressed representation may include one or more additional subsets (such as the second subset described above) of position parameters and the measures of the property of the scene corresponding to the one or more additional subsets.

The compressed representation of the scene may not include any additional information defining how the measures of the property of the scene vary in between the positions indicated by the subset of position parameters included in the compressed representation. For example, the method of compressing the representation may not include fitting any functions to the measures of property of the scene. The compressed representation may not include any function parameters defining functions which express variations of the measures of the property of the scene.

The methods of compression of a scene representation described above with reference to FIG. 3 may be particularly suitable for parallelisation. That is, different parts of one or more steps of the compression methods may be performed in parallel by different processing cores and/or processing units. The compression methods are particularly suitable for parallelisation because the calculations involved can often be carried out in isolation to other calculations forming part of the same method step. For example, different processing cores and/or processing units may determine derivatives of measures of a property of the scene for different portions of the scene in parallel and independently of each other. That is, at least some aspects of step 301 of FIG. 3 may be performed for different portions of a scene in parallel and by different processing cores and/or processing units. The suitability of the compression methods for parallelisation may mean that particular advantages can be realised by implementing the compression methods on one or more GPUs.

As was explained above, a representation of a scene (such as a depth map) may be compressed at a first computing apparatus or device (such as the media sever 101 of FIG. 1) and the compressed representation may be transmitted to a second computing apparatus or device (such as the rendering module 102). The compressed representation may be decompressed (e.g. at the second computing apparatus or device such as the rendering module 102) so as to reproduce the original uncompressed representation from the compressed representation. Decompression of a compressed representation may find particular use when the representation is used for rendering an image of the scene, since in such applications a measure of the property of the scene may be needed for each pixel in the rendered image.

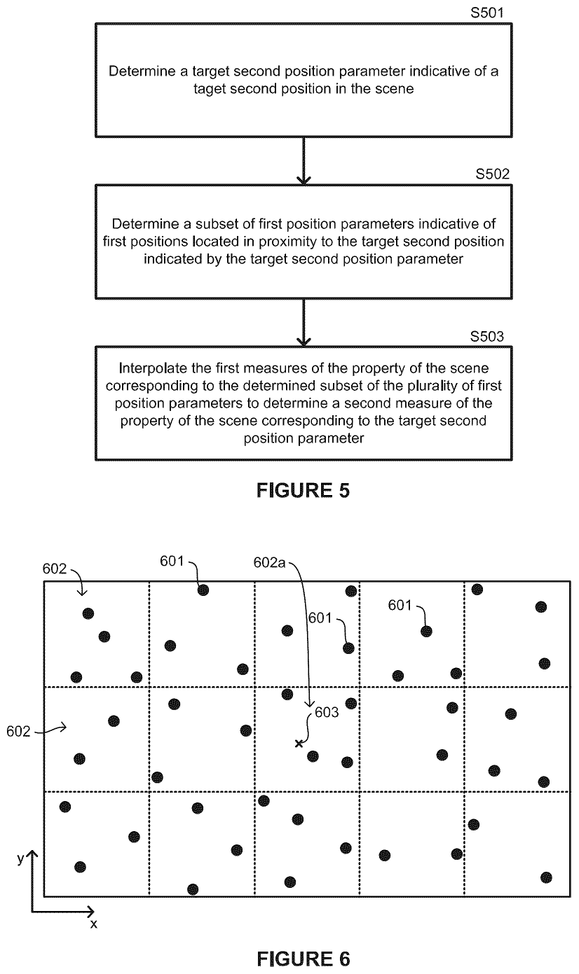

FIG. 5 is a flow chart of an example method of decompressing a compressed representation of the scene. The representation of the scene and the compressed representation of the scene may include any of the properties described above with reference to methods of compressing the representation. For example, the compressed representation of the scene may have been compressed according to any of the compression methods and features described above.

The compressed representation of the scene may comprise first measures of a property of the scene corresponding to a plurality of first position parameters indicative of first positions in the scene. The method of decompression comprises determining second measures of the property of the scene corresponding to a plurality of second position parameters indicative of second positions in the scene. For example, the first position parameters may correspond with a first subset of pixel positions in an image to be rendered (e.g. subset of the pixels or viewing directions of a depth map). The second position parameters may correspond with the remaining pixel positions (or equivalently viewing directions) in the image. The decompression method may therefore amount to reproducing the data points in the original scene representation which are missing from the compressed representation. The second measures of the property of the scene corresponding to a plurality of second position parameters indicative of second positions in the scene (the data points which are missing in the compressed representation) may be determined in dependence on the first measures of a property of the scene corresponding to a plurality of first position parameters indicative of first positions in the scene (the data points included in the compressed representation).

At step 501 of FIG. 5 a target second position parameter indicative of a target second position in the scene is determined. The target second position parameter may be any second position parameter for which a second measure of the property of the scene has not yet been determined. For example, a decompression method may include iterating through the steps of the method of FIG. 5 for each second position in the scene (i.e. for each data point missing in the compressed representation).

At step 502 a subset of the first position parameters indicative of first positions located in proximity to the target second position are determined. The subset of first position parameters are determined based on the target second position. The subset of first position parameters may, for example, comprise a set of nearest neighbours or an approximation of nearest neighbours to the target second position. The subsets of first position parameters may comprise only some of the nearest neighbours to the target second position.

A number of different methods may be used to determine the subset of first position parameters. As a first step, the first position parameters may be sorted into an organised data structure in order to facilitate the identification of the subset of first position parameters. For example, the parameter space characterised by the first position parameters may be divided into a plurality of segments. The first position parameters may then be sorted into the segments and one or more proximate segments to the second position parameter may be searched to identify the subset of first position parameters.

FIG. 6 is a schematic illustration of a parameter space on an x-axis and a y-axis and a plurality of first positions 601 in the parameter space. The parameter space may, for example, correspond with the positions of pixels of an image to be rendered. For example, the x-axis and y-axis shown in FIG. 6 may correspond with the axes of FIGS. 2 and 4. Each of the first positions 601 marked with a dot in FIG. 6 is defined by a first position parameter included in the compressed representation.

In the example of FIG. 6 the parameter space has been divided into uniform segments 602 separated by the dashed lines shown in FIG. 6. Each of the first positions 601 falls within one of the segments 602. Also shown in FIG. 6 is an example target second position 603 situated in a segment labelled 602a in FIG. 6. In at least some examples, the subset of first position parameters may be determined simply as the first position parameters which define positions in the same segment as the target second position. For example, for the target second position 603 shown in FIG. 6, the subset of first position parameters may be determined as the first position parameters which define first positions 601 situated in the same segment 602a as the target second position. In at least some examples, one or more first positions situated in neighbouring segments to the segment 602a in which the target second position 603 is located may be included in the subset of first position parameters.

In some examples, more advanced methods of dividing the parameter space into segments may be used. For example, the first positions may be sorted onto a k-dimensional (k-d) tree in order to divide the parameter space into segments. In some examples, the first positions may be used as seeds to determine a plurality of Voronoi cells.

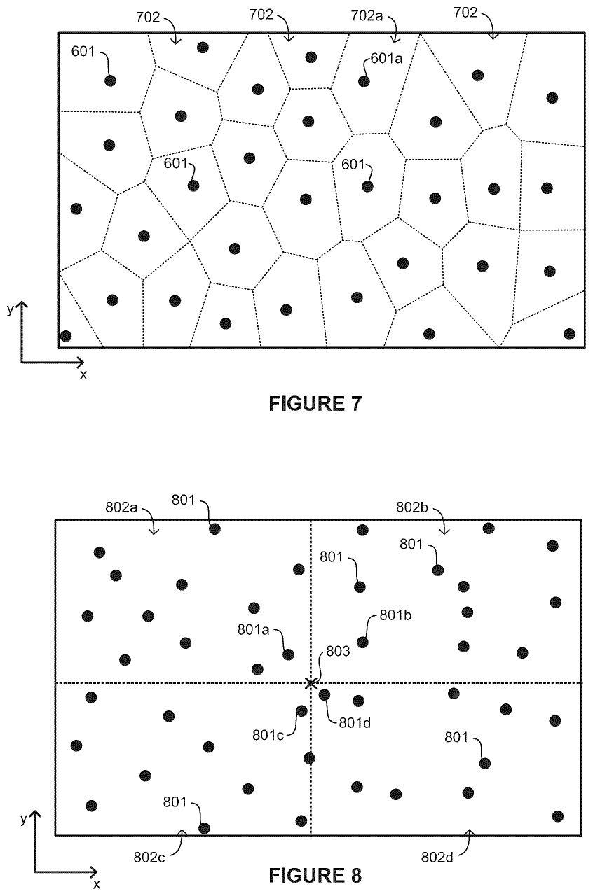

FIG. 7 is a schematic illustration of a plurality of Voronoi cells 702 determined for a plurality of first positions 601. The same x-y parameter space is used in FIG. 7 as described above in connection with FIGS. 2, 4 and 6. Each first position 601 has a corresponding Voronoi cell 702 which represents a region of parameter space throughout which the respective first position 601 is the closest first position 601. For example, the first position labelled 601a in FIG. 7 is the closest first position 601 to all of the points which lie inside the corresponding Voronoi cell labelled 702a in FIG. 7. Voronoi cells may be determined using any suitable method such as by using a jump flooding algorithm.

In examples in which the parameter space is divided into segments by determining Voronoi cells 702 using the plurality of first positions 601 as seeds, a target second position may be evaluated to determine which Voronoi cell 702 it is situated in. The subset of proximate first position parameters may then be determined to include the first position parameter of the first position corresponding to the Voronoi cell 702 in which the target second position is situated and first position parameters of one or more first positions corresponding to one or more neighbouring Voronoi cells 702.

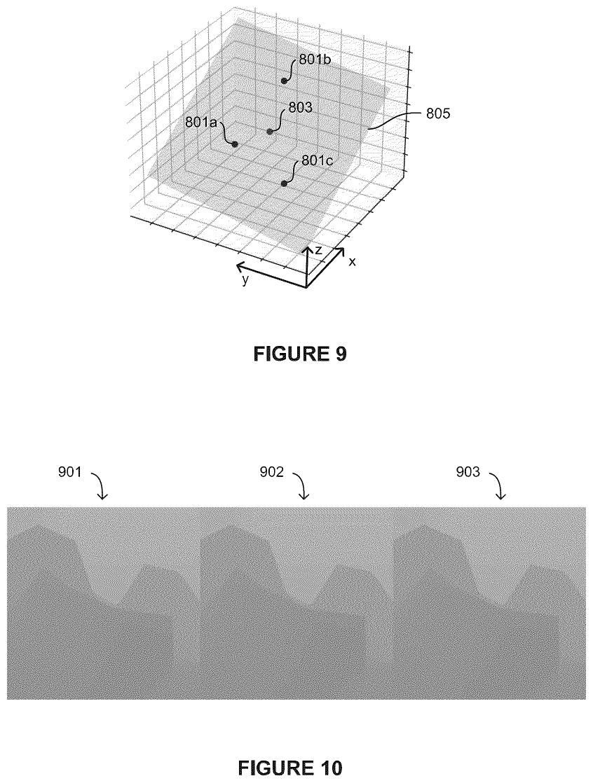

At step 503 of the method of FIG. 5, the first measures of the property of the scene corresponding to the determined subset of the plurality of first position parameters may be interpolated to determine a second measure of the property of the scene corresponding to the target second position parameter. Any suitable interpolation method may be used such as linear interpolation or an inverse distance weights interpolation. How the subset of the plurality of first position parameters is determined in step 502 may depend on the interpolation method used in step 503. A simple example of a possible combination of methods used in steps 502 and 503 will be described with reference to FIGS. 8 and 9.

FIG. 8 is a schematic illustration of a plurality of first positions 801 and a target second position 803. The same x-y parameter space is used in FIG. 8 as is described above in connection with FIGS. 2, 4, 6 and 7. The parameter space illustrated in FIG. 8 is divided into segments 802a, 802b, 802c, 802d based on the position of the target second position 803. In particular, the parameter space is divided into four segments 802a, 802b, 802c, 802d such that the target second position lies at the intersection between all four segments 802a, 802b, 802c, 802d. Each of the segments 802a, 802b, 802c, 802d is then searched to identify the closest first position 801 in each segment to the target second position 803. For example, a first position labelled 801a in FIG. 8 is identified as the closest first position in the upper left segment 802a as viewed in FIG. 8. A first position labelled 801b in FIG. 8 is identified as the closest first position in the upper right segment 802b as viewed in FIG. 8. A first position labelled 801c in FIG. 8 is identified as the closest first position in the lower left segment 802c as viewed in FIG. 8. A first position labelled 801d in FIG. 8 is identified as the closest first position in the lower right segment 802d as viewed in FIG. 8.

The closest first positions 801a, 801b, 801b, 801d may be identified as potential first positions to include in the first subset of first positions for the target second position 803 for performing linear interpolation. In some examples three of the four closest first positions 801a, 801b, 801b, 801d may be selected to form the first subset of first positions for the target second position 803. Three of the four closest first positions 801a, 801b, 801b, 801d may be selected which meet a set of criteria. The criteria may, for example, include a condition that the three closest first positions are not colinear with each other (i.e. they do not all lie on a straight line) and a condition that the target second position 803 lies within a triangle formed by the three closest first positions. For sake of illustration, in the example of FIG. 8 the closest first positions 801a, 801b, 801c in the upper left 802a, upper right 802b and lower left 802c segments may be selected as meeting the set of criteria. These first positions 801a, 801b, 801c may therefore form the first subset of first positions on which the interpolation of step 503 is based.

FIG. 9 is a schematic illustration of the selected subset of first positions 801a, 801b, 801c in three-dimensional space. The x and y-axes shown in FIG. 9 correspond with the x and y-axes of FIG. 8. Also shown in FIG. 9 is a z-axis. Alternatively, u and v axes may be used to denote position in two-dimensions and x, y and z axes may be used to denote position in three dimensions. In the example of FIG. 9, the representation of the scene comprises a depth map in which the measures of the property of the scene comprise a distance to a surface in the scene corresponding to each first position 801. In the illustration of FIG. 9 the position of the points on the z-axis corresponds with the distance to a surface (depth) corresponding with each of the first positions 801a, 801b, 801c. A second measure of the property of the scene (a distance to a surface) for the target second position 803 may be determined by interpolating the first measures (distances) corresponding to the selected subset of first positions 801a, 801b, 801c. In the example, of FIG. 9 linear interpolation is used. In particular, a plane 805 is determined in which each of the subset of first positions 801a, 801b, 801c lies. The second measure of the property of the scene (a distance to a surface) is determined by determining the position on the z-axis of the plane at the x and y position corresponding to the target second position 803.

Whilst a specific method of linear interpolation has been described above with reference to FIGS. 8 and 9, in general any suitable form of interpolation may be used in step 503. For example, an inverse distance weights method of interpolation may be used. In such examples, a weight may be determined for each of the subset of first position parameters determined at step 502. In particular each weight may be dependent on a distance (e.g. a Euclidean distance) between the respective first position and the target second position. The distances may correspond with distances in the parameter space to which the first and second position parameters relate (for example, in the x-y plane in the depicted examples). The determined weights may be inversely proportional to the distance between the respective first position and the target second position. That is, a first position located further from the target second position may be assigned a lower weight than a first position which is located closer to the target second position. The determined weights may be used to determine a weighted average of the first measures of a property of the scene (e.g. distances to a surface) corresponding to the subset of the plurality of first parameters. In such examples, measures corresponding with first positions situated closer to the target second position may contribute more to the weighted average than measures corresponding with first positions situated further from the target second position. The weighted average of the first measures of the property of the scene may form the determined second measure of the property of the scene for the target second position.

As was explained above, steps 501, 502 and 503 of the method of FIG. 5 may be performed for each second position for which a second measure of the property of the scene needs to be determined to replicate the original uncompressed representation of the scene based on the compressed representation. For example, a plurality of iterations of the method of FIG. 5 may be performed to determine second measures for each of the plurality of second positions.

Advantageously, the method of FIG. 5 may be performed for each target second position parameter independently of other target second position parameters. That is, each second position parameter can be considered in isolation and a second measure of the property of the scene (e.g. a distance to a surface) can be determined for a given second position parameter independently of determining a second measure of the property of the scene for another second position parameter. The ability to determine second measures of the property of the scene corresponding to different second position parameters independently means that the decompression method is well suited to parallelisation.

In at least some examples, the steps of the method of FIG. 5 may be performed for different second positions and second position parameters in parallel. For example, different processing cores and/or different processing units may perform the steps of the method of FIG. 5 for different second positions and second position parameters in parallel. The suitability of the decompression methods for parallelisation may mean that particular advantages can be realised by implementing the decompression methods on one or more GPUs.

A decompressed representation of the scene is formed comprising both the first measures of the property of the scene corresponding to the plurality of first position parameters and the determined second measures of the property of the scene corresponding to each of the second position parameters. The decompressed representation of the scene comprises a reproduction of the original uncompressed representation of the scene before compression.

The decompressed representation of the scene may be suitable for use in rendering an image of the scene. For example, taking the system 100 of FIG. 1, the rendering module 102 may decompress a compressed representation of the scene received from the media server 101. The decompressed representation of the scene may be used by the rendering module to render an image of the scene for display by the display device 103.

As was explained above, the compression and decompression methods disclosed herein have been found to be able to achieve high compression ratios whilst still being able to reproduce an original uncompressed scene representation to a high degree of accuracy. FIG. 10 is a schematic depiction of a portion of the depth map of FIG. 2 in its original uncompressed form and after compression and decompression using different compression and decompression methods. The left-most portion of FIG. 10 labelled 901 is a depiction of the portion of the depth map in its original uncompressed form. The central portion of FIG. 10 labelled 902 is a depiction of the same portion of the same depth map after the depth map has been compressed and decompressed using a compression method using a discrete cosine transform (DCT). The right-most portion of FIG. 10 labelled 903 is a depiction of the same portion of the same depth map after the depth map has been compressed and decompressed using the compression and decompression methods described herein. That is, the portion of the depth map 903 shown in the right-most portion of FIG. 10 was compressed using a method according to the steps of FIG. 3 and the compressed representation was decompressed using a method according to the steps of FIG. 5.

The compression used to form the portion of the depth map 902 shown in the central portion of FIG. 10 (using a DCT compression method) achieved a compression ratio of approximately 4:1. That is, the memory footprint of the original uncompressed depth map was approximately four times larger than the memory footprint of the compressed depth map. The compression used to form the depth map 903 shown in the right-most portion of FIG. 10 (using the compression methods described herein) achieved a compression ratio of approximately 17:1. That is, the memory footprint of the original uncompressed depth map was approximately seventeen times larger than the memory footprint of the compressed depth map. The compression methods disclosed herein were therefore able to achieve a significantly higher compression ratio than an equivalent compression using a DCT method. As was described above, achieving a higher compression ration may significantly reduce the network bandwidth needed to transmit a compressed representation between devices.

On close comparison of the central portion 902 of FIG. 10 (the decompressed portion of the depth map having undergone compression using a DCT method) with the right-most portion 903 of FIG. 10 (the decompressed portion of the depth map having undergone compression using the method described herein), it can be seen that the right-most portion 903 of FIG. 10 is a more accurate reproduction of the original uncompressed depth map 901. In particular, it can be seen from the central portion 902 of FIG. 10 that using a DCT compression method degrades the appearance of transitions between different surfaces in the depth map when compared to the right-most portion 903 of FIG. 10 which more accurately reproduces the transitions between surfaces.

As was explained above, the compression and decompression methods described herein have been found to reproduce an original uncompressed scene representation to greater accuracy than other forms of compression and decompression methods (e.g. using a DCT compression). Furthermore, the compression methods described herein are capable of achieving a higher compression ratio than other compression methods which can significantly reduce network bandwidth and/or storage requirements.

The compression and decompression methods described herein have also been shown to be particular suitable for parallelisation. Aspects of the methods described herein may therefore be performed by different processing cores and/or processing units in parallel. In particular, the compression and/or decompression methods described herein may be implemented on one or more GPUs. The suitability of the methods described herein for parallelisation may mean that significant speed improvements can be achieved through implementation on one or more GPUs.

Whilst particular examples have been described herein with reference to compression and decompression of depth maps, any aspect or features of the compression and/or decompression methods described herein may be performed for any representation of a three-dimensional suitable for rendering an image of the scene. In general, the compression and decompression methods described herein may be used to compress and/or decompress any representation of a three-dimensional scene which comprises measures of a property of the scene corresponding to a plurality of different position parameters indicative of positions in the scene.

Aspects, steps and/or features of the methods described herein may be performed by one or more computing devices or computing apparatus. For example, as described above a compression method as described herein may be performed by a media server 101, which is an example of a computing device or computing apparatus. Furthermore, a decompression method as described herein may be performed by one or more rendering modules 102 which may be realised as one or more computing devices and/or computing apparatus.

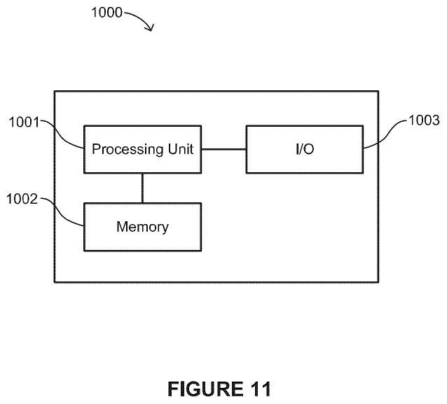

A computing device or computing apparatus may be realised in any suitable form. FIG. 11 is a schematic depiction of a computing device 1000 or apparatus which may be used to implement all or part of any method described herein. For example, the device 1000 or apparatus may be used to realise all or part of a media sever 101 and/or rendering module 102.

The device 1000 may include at least one processing unit 1001, memory 1002 and an input/output (I/O) interface 1000. The processing unit 1001 may include any suitable processer and/or combination of processors. For example, the processing unit 1001 may include one or more of a Central Processing Unit (CPU) and a Graphical Processing Unit (GPU). The memory 1002 may include volatile memory and/or non-volatile/persistent memory. The memory 1002 may, for example, be used to store data such as an operating system, instructions to be executed by the processing unit (e.g. in the form of software to be executed by the processing unit), configuration information related to the device 1000 and/or data related to a scene to be rendered. For example, the memory 1002 may be used to store representations of one or more properties of a three dimensional scene. In some examples, the memory 1002 may be used to store instructions for executing any of the methods disclosed herein.

At least the processing unit 1001 is connected to an input/output (I/O) interface 1003. The I/O interface 100 facilitates communication with one or more other devices, network nodes or modules in a network. For example, the I/O interface 1003 may be operable to transmit and/or receive communications to/from other devices in a network. In some examples, the I/O interface 1003 may be operable to transmit and/or receive communications over an air interface. For example, the I/O interface 1003 may include a transmitter and/or a receiver for transmitting and/or receiving wireless communication (e.g. radio frequency signals). In some examples, the I/O interface 1003 may include a transceiver configured to receive and transmit wireless communication (e.g. radio frequency signals). In some examples, the I/O interface 1003 may be operable to additionally or alternatively communicate over one or more wired connections.

Optionally, the device 1000 may further include a display. For example, the device 1000 may include a display for displaying information to a user of the device 1000. The display may comprise any suitable electronic display. The display may be connected to at least to the processing unit 1001. The processing unit 1001 may generate display signals which are sent to the display in order to cause the display to display information.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples.

1. A computer implemented method of compressing a representation of a three-dimensional scene, wherein the representation comprises measures of a property of the scene corresponding to a plurality of different position parameters indicative of positions in the scene, the method comprising:
detecting a first subset of the plurality of position parameters, which are indicative of positions of discontinuities in the measures of the property of the scene; and
storing the first subset of the plurality of position parameters and the measures of the property of the scene corresponding to the first subset of the plurality of position parameters as a compressed representation of the scene.

2. The computer implemented method of claim 1, wherein the measures of a property of the scene comprise measures of a property of surfaces in the scene corresponding to the plurality of different position parameters.

3. The computer implemented method of claim 2, wherein the measures of a property of surfaces in the scene comprise measures indicative of geometry of surfaces in the scene corresponding to the plurality of different position parameters.

4. The computer implemented method of claim 1, wherein the plurality of different position parameters correspond with a plurality of different viewing directions originating at a viewing position and wherein each of the measures of a property of the scene correspond with a viewing direction of the plurality of viewing directions.

5. The computer implemented method of claim 4, wherein the representation of the three-dimensional scene comprises a depth map and wherein the measures of a property of the scene comprise distances to a surface in the three-dimensional scene along the plurality of different viewing directions from the viewing position.

6. The computer implemented method of claim 1, wherein detecting the first subset of the plurality of position parameters which are indicative of positions of discontinuities in the measures of the property of the scene, comprises:
determining derivatives of the measures of the property of the scene with respect to changes in the position parameter;
determining the first subset of the plurality of position parameters as position parameters at which a magnitude of the determined derivatives is greater than a derivate threshold.

7. The computer implemented method of claim 6, wherein determining derivatives of the measures of the property of the scene comprises determining second derivatives of the measures of the property of the scene with respect to changes in the position parameter.

8. The computer implemented method of claim 6, further comprising:
determining the derivative threshold in dependence on a number of position parameters at which the magnitude of the determined derivatives is greater than the derivative threshold.

9. The computer implemented method of claim 1, further comprising:
sampling the plurality of different position parameters to determine a second subset of the plurality of position parameters; and
storing the second subset of the plurality of position parameters and the measures of the property of the scene corresponding to the second subset of the plurality of position parameters in addition to the first subset of the plurality of position parameters and the measures of the property of the scene at the first subset of the plurality of position parameters as a compressed representation of the scene.

10. A computer implemented method of decompressing a compressed representation of a three-dimensional scene, the compressed representation comprising first measures of a property of the scene corresponding to a plurality of first position parameters indicative of first positions in the scene, the method comprising;
determining second measures of the property of the scene corresponding to a plurality of second position parameters indicative of second positions in the scene, wherein determining the second measures of the property of the scene corresponding to the plurality of second position parameters comprises, for each second position parameter:
determining a subset of the plurality of first position parameters which are indicative of first positions which are located in proximity to the second position indicated by the second position parameter; and
interpolating the first measures of the property of the scene corresponding to the determined subset of the plurality of first parameters to determine a second measure of the property of the scene corresponding to the second position parameter; and
forming a decompressed representation of the three-dimensional scene, the decompressed representation comprising the first measures of the property of the scene corresponding to the plurality of first position parameters and the determined second measures of the property of the scene corresponding to the plurality of second position parameters.

11. The computer implemented method of claim 10, wherein the first measures and determined second measures of a property of the scene comprise measures of a property of surfaces in the scene corresponding to the plurality of first and second position parameters respectively.

12. The computer implemented method of claim 11, wherein the measures of a property of surfaces in the scene comprise measures indicative of geometry of surfaces in the scene.

13. The computer implemented method of claim 10, wherein the plurality of first position parameters and the plurality of second position parameters correspond with a plurality of different viewing directions originating at a viewing position and wherein each of the first measures and second measures of a property of the scene correspond with a viewing direction of the plurality of viewing directions.

14. The computer implemented method of claim 13, wherein the compressed representation of the three-dimensional scene comprises a portion of a depth map and wherein the first and second measures of the property of the scene comprise distances to a surface in the three-dimensional scene along the plurality of different viewing directions from the viewing position.

15. The computer implemented method of claim 10, wherein interpolating the first measures corresponding to the subset of the plurality of first parameters to determine a second measure of the property of the scene corresponding to the second position parameter comprises linear interpolation.

16. The computer implemented method of claim 10, wherein interpolating the first measures corresponding to the subset of the plurality of first parameters to determine a second measure of the property of the scene corresponding to the second position parameter comprises:
determining weights associated with each of the subset of the plurality of first position parameters in dependence on distances between the first positions indicated by the first position parameters and the second position indicated by the second position parameter; and
determining a weighted average of the first measures of the property of the scene corresponding to the subset of the plurality of first parameters, wherein the weighted average is determined using the determined weights associated with each of the subset of the plurality of first position parameters.

17. The computer implemented method of claim 10, wherein determining a subset of the plurality of first position parameters which are indicative of first positions which are located in proximity to the second position indicated by the second position parameter comprises:
dividing a parameter space characterised by the first position parameters into a plurality of segments in which each of the first position parameters fall;
identifying at least one proximate segment in which the second position parameter falls and/or which neighbours a segment in which the second position parameter falls; and
determining the subset of the plurality of first position parameters as at least some of the plurality of first position parameters which are situated in the at least one proximate segment.

18. The computer implemented method of claim 17, wherein dividing the parameter space characterised by the first position parameters into a plurality of segments in which each of the first position parameters fall comprises at least one of:
determining a plurality of Voronoi cells based on the plurality of first position parameters as seeds;
constructing a k-d tree based on the plurality of first position parameters; and
dividing the parameter space into uniform segments.

19. (canceled)

20. A method of distributing a representation of a three-dimensional scene, the method comprising:
compressing a representation of a three-dimensional scene by at least one first computing apparatus;
compressing a representation of a three-dimensional scene comprising;
detecting a first subset of a plurality of position parameters, which are indicative of positions of discontinuities in measures of a property of the scene; and
storing the first subset of the plurality of position parameters and the measures of the property of the scene corresponding to the first subset of the plurality of position parameters as a compressed representation of the scene;
transmitting the compressed representation of the three-dimensional scene to at least one second computing apparatus; and
decompressing the compressed representation of the three-dimensional scene performed by the at least one second computing apparatus, decompressing the decompressed representation of the three-dimensional scene comprising;
determining second measures of the property of the scene corresponding to a plurality of second position parameters indicative of second positions in the scene, wherein determining the second measures of the property of the scene corresponding to the plurality of second position parameters comprises, for each second position parameter:
determining a subset of the plurality of first position parameters which are indicative of first positions which are located in proximity to the second position indicated by the second position parameter; and
interpolating first measures of the property of the scene corresponding to the determined subset of the plurality of first parameters to determine a second measure of the property of the scene corresponding to the second position parameter; and
forming a decompressed representation of the three-dimensional scene, the decompressed representation comprising the first measures of the property of the scene corresponding to the plurality of first position parameters and the determined second measures of the property of the scene corresponding to the plurality of second position parameters.

21. The method of claim 20, further comprising: rendering, at the at least one second computing apparatus, an image of the three-dimensional scene using the decompressed representation of the three-dimensional scene.

22.-28. (canceled)
